(19) United States
(12) Patent Application Publication
(10) Pub. No.: US 2026/0225370 A1
(43) Pub. Date: Aug. 6, 2026

(54) INKJET PRINTING APPARATUS

(71) Applicant: SCREEN Holdings Co., Ltd., Kyoto (JP)

(72) Inventors: Hideaki ONISHI, Kyoto-shi, Kyoto (JP); Yuto SUZUKI, Kyoto-shi, Kyoto (JP); Takanori TSUJI, Kyoto-shi, Kyoto (JP); Akihiro OGAWA, Kyoto-shi, Kyoto (JP); Noboru HAMAGUCHI, Kyoto-shi, Kyoto (JP); Miki NAKAGAWA, Kyoto-shi, Kyoto (JP)

(21) Appl. No.: 19/152,276

(22) PCT Filed: Nov. 24, 2023
(86) PCT No.: PCT/JP2023/042114

§ 371 Date: Jul. 30, 2025

(30) Foreign Application Priority Data
Feb. 22, 2023 (JP) 2023-025978
Sep. 25, 2023 (JP) 2023-161224

(51) Int. Cl. B41J 2/175; B41J 2/18; B41J 2/20

(52) U.S. Cl. CPC B41J 2/17566; B41J 2/17596; B41J 2/18; B41J 2/20

(57) ABSTRACT

To provide a technique for reducing degradation of ink due to overheating in an inkjet printing apparatus having a circulation flow path. An inkjet printing apparatus includes a circulation pump, a replenishment pump, and a controller. The circulation pump is located between a heater and a recovery tank in a connection pipe and feeds ink in the recovery tank to a supply tank. The replenishment pump is located in a replenishment pipe and feeds the ink in a replenishment tank to a connection pipe. The replenishment pipe is connected to a connection point between the heater and the recovery tank in the connection pipe. While the heater is working, the controller controls the circulation pump and the replenishment pump in such a manner that the flow rate of the ink to pass through the heater becomes equal to or greater than a limit flow rate.

### TECHNICAL FIELD

A subject matter disclosed in the present description relates to an inkjet printing apparatus.

### BACKGROUND ART

In some conventional cases, an inkjet printing apparatus is provided with a circulation flow path along which ink is supplied to an ejection head from which the ink is ejected to a print medium, the ink not having been ejected from the ejection head is recovered, and then the ink is supplied again to the ejection head. The inkjet printing apparatus with such an ink circulation flow path is described in Patent Literature 1, for example.

An ink supplier of Patent Literature 1 circulates ink by supplying the ink from an ink tank to a head and recovering the ink from the head into the ink tank. A supply pump controls a pressure (feeding amount) in a supply flow path along which the ink is supplied from the ink tank to the head. A recovery pump controls a pressure (feeding amount) in a recovery flow path along which the ink is recovered from the head into the ink tank.

### CITATION LIST

### Patent Literature

Patent Literature 1: Japanese Patent Application Laid-Open No. 2018-43518

### SUMMARY OF INVENTION

### Technical Problem

Some ink used in the inkjet printing apparatus is changed in viscosity by being heated. In some cases, to feed such ink from the ink tank to the head smoothly and eject the ink stably from the head, the ink before being ejected is pre-heated by a heater to be maintained in a suitable temperature range.

However, if the flow of the ink is stopped or decelerated while the heater is at a high temperature, the ink is heated to a high temperature with the heat of the heater, resulting in a risk of developing degradation of the ink.

The present invention is intended to provide a technique for reducing degradation of ink due to overheating in an inkjet apparatus having a circulation flow path.

### Solution to Problem

To solve the above problem, a first aspect is intended for an inkjet printing apparatus comprising: an ejection head having a nozzle from which ink is ejected; a supply tank storing the ink to be supplied to the ejection head; a recovery tank storing the ink recovered from the ejection head; a connection pipe forming connection between the supply tank and the recovery tank; a heater located in the connection pipe and heating the ink in the connection pipe; a circulation pump located between the heater and the recovery tank in the connection pipe and feeding the ink in the recovery tank to the supply tank; a replenishment tank storing the ink to be replenished into the supply tank; a replenishment pipe forming connection between the replenishment tank and the connection pipe; a replenishment pump located in the replenishment pipe and feeding the ink in the replenishment tank to the connection pipe; and a controller that controls the circulation pump and the replenishment pump. The replenishment pipe is connected to a position between the heater and the recovery tank in the connection pipe. While the heater is working, the controller controls the circulation pump and the replenishment pump in such a manner that the flow rate of the ink to pass through the heater becomes equal to or greater than a limit flow rate.

According to a second aspect, the inkjet printing apparatus of the first aspect comprises: a supply tank remaining amount detector that detects a supply tank remaining amount showing the amount of the ink stored in the supply tank; and a recovery tank remaining amount detector that detects a recovery tank remaining amount showing the amount of the ink stored in the recovery tank. The controller controls the circulation pump and the replenishment pump on the basis of the supply tank remaining amount detected by the supply tank remaining amount detector and the recovery tank remaining amount detected by the recovery tank remaining amount detector.

According to a third aspect, in the inkjet printing apparatus of the second aspect, if the supply tank remaining amount detected by the supply tank remaining amount detector is equal to or greater than a first supply remaining amount and if the recovery tank remaining amount detected by the recovery tank remaining amount detector is equal to or greater than a first recovery remaining amount, the controller sets a flow rate at the circulation pump to a basic circulation flow rate and sets a flow rate at the replenishment pump to a basic replenishment flow rate, and a sum of the basic circulation flow rate and the basic replenishment flow rate is equal to or greater than the limit flow rate.

According to a fourth aspect, in the inkjet printing apparatus of the third aspect, if the supply tank remaining amount detected by the supply tank remaining amount detector is less than the first supply remaining amount, the controller sets a flow rate at the circulation pump to a first circulation flow rate higher than the basic circulation flow rate.

According to a fifth aspect, in the inkjet printing apparatus of the fourth aspect, if the supply tank remaining amount detected by the supply tank remaining amount detector is less than the first supply remaining amount, the controller sets a flow rate at the replenishment pump to the basic replenishment flow rate, and a sum of the first circulation flow rate and the basic replenishment flow rate is equal to or greater than the limit flow rate.

According to a sixth aspect, in the inkjet printing apparatus of the third or fourth aspect, if the recovery tank remaining amount detected by the recovery tank remaining amount detector is less than the first recovery remaining amount, the controller sets a flow rate at the circulation pump to a second circulation flow rate lower than the basic circulation flow rate and sets a flow rate at the replenishment pump to a first replenishment flow rate higher than the basic replenishment flow rate, and a sum of the second circulation flow rate and the first replenishment flow rate is equal to or greater than the limit flow rate.

According to a seventh aspect, in the inkjet printing apparatus of the sixth aspect, if the recovery tank remaining amount detected by the recovery tank remaining amount detector is less than the first recovery remaining amount and if the supply tank remaining amount detected by the supply tank remaining amount detector is equal to or greater than a second supply remaining amount larger than the first supply remaining amount, the controller sets a flow rate at the circulation pump to a third circulation flow rate lower than the basic circulation flow rate and sets a flow rate at the replenishment pump to a second replenishment flow rate lower than the first replenishment flow rate, and a sum of the third circulation flow rate and the second replenishment flow rate is equal to or greater than the limit flow rate.

According to an eighth aspect, the inkjet printing apparatus of the third or fourth aspect further comprises a liquid feeder that feeds the ink from the supply tank toward the head.

According to a ninth aspect, in the inkjet printing apparatus of the eighth aspect, the controller controls the circulation pump and the replenishment pump in such a manner that a sum of the basic circulation flow rate and the basic replenishment flow rate becomes equal to the flow rate of the ink to be fed from the supply tank to the ejection head by the liquid feeder.

According to a tenth aspect, in the inkjet printing apparatus of the eighth or ninth aspect, the liquid feeder makes an internal pressure in the supply tank higher than an internal pressure in the recovery tank.

According to an eleventh aspect, in the inkjet printing apparatus of the first or second aspect, the limit flow rate is equal to or greater than 50 ml/min.

According to a twelfth aspect, the inkjet printing apparatus of the first or second aspect further comprises a temperature sensor that measures the temperature of the ink flowing into the heater. The limit flow rate is changed in response to a temperature measured by the temperature sensor.

According to a thirteenth aspect, in the inkjet printing apparatus of the twelfth aspect, the limit flow rate determined if a measured temperature measured by the temperature sensor is lower than a predetermined threshold temperature is higher than the limit flow rate determined if the measured temperature exceeds the threshold temperature.

### Advantageous Effects of Invention

According to the inkjet printing apparatus of the first to thirteenth aspects, it is possible to reduce degradation of the ink due to overheating.

According to the inkjet printing apparatus of the second aspect, it is possible to control the circulation pump and the replenishment pump in such a manner that the ink remaining amount in the supply tank and the ink remaining amount in the recovery tank become proper amounts.

According to the inkjet printing apparatus of the third aspect, by making a sum of the basic circulation flow rate and the basic replenishment flow rate equal to or greater than the limit flow rate, it becomes possible to reduce degradation of the ink.

According to the inkjet printing apparatus of the fourth aspect, it is possible to replenish the ink from the recovery tank into the supply tank.

According to the inkjet printing apparatus of the fifth aspect, by making a sum of the first circulation flow rate and the basic replenishment flow rate equal to or greater than the limit flow rate, it becomes possible to reduce degradation of the ink.

According to the inkjet printing apparatus of the sixth aspect, even if a flow rate at the circulation pump is reduced for avoiding reduction in the recovery tank remaining amount, it is still possible to make a flow rate at the heater higher than the limit flow rate by increasing a flow rate at the replenishment pump.

According to the inkjet printing apparatus of the seventh aspect, it is possible to reduce degradation of the ink due to overheating while avoiding overflow of the supply tank.

### BRIEF DESCRIPTION OF DRAWINGS

FIG. 1 is a view showing the configuration of an inkjet printing apparatus according to an embodiment.

FIG. 2 is a view conceptually showing the configurations of one ink supplier and one ejection head.

FIG. 3 is a perspective view showing an ejection head and a part of the ink supplier.

FIG. 4 is a block diagram showing connection between a controller and each unit of the inkjet printing apparatus.

FIG. 5 is a view showing a flow of a circulation process performed by the controller.

FIG. 6 is a view showing a flow of the circulation process performed by the controller.

FIG. 7 is a view showing a flow of the circulation process performed by the controller.

FIG. 8 is a view showing each state of the ink supplier in the circulation process.

FIG. 9 is a view showing each state of the ink supplier in the circulation process.

FIG. 10 is a view showing each state of the ink supplier in the circulation process.

FIG. 11 is a view showing each state of the ink supplier in the circulation process.

FIG. 12 is a view showing each state of the ink supplier in the circulation process.

FIG. 13 is a view showing each state of the ink supplier in the circulation process.

FIG. 14 is a view for explaining a relationship between the temperature of ink entering a heater and a limit flow rate.

FIG. 15 is a view showing the state of the ink supplier.

### DESCRIPTION OF EMBODIMENTS

An embodiment of the present invention will now be described with reference to the drawings. Constituting elements in the embodiment are described merely as examples, and the scope of the present invention is not intended to be limited only to these elements. To facilitate understanding, the size of each part or the number of such parts in the drawings may be illustrated in an exaggerated manner or a simplified manner, as needed.

### Embodiment

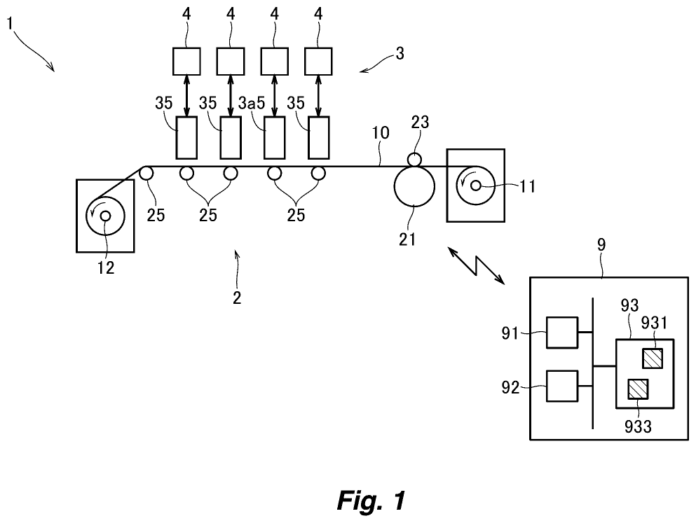

FIG. 1 is a view showing the configuration of an inkjet printing apparatus 1 according to the embodiment. The inkjet printing apparatus 1 is an inkjet-system printing machine that records characters or images on a surface of elongated strip-shaped continuous paper 10 by ejecting droplets of aqueous ink from a plurality of head units 35 toward the continuous paper 10 while transporting the continuous paper 10. The continuous paper 10 is an example of a print medium. The print medium may be cut paper, a plastic film, corrugated cardboard, metallic foil, or a glass base material, for example. In the inkjet printing apparatus 1, the ink ejected from the head unit 35 is aqueous ink, for example. However, the ink ejected from the head unit 35 may be oil-based ink or UV ink, for example.

As shown in FIG. 1, the inkjet printing apparatus 1 includes a unwinding roller 11, a take-up roller 12, a transport unit 2, a printing unit 3, and a controller 9.

The unwinding roller 11 holds the continuous paper 10 wound in a roll-shape thereon. The unwinding roller 11 rotates to feed the continuous paper 10 and supplies the continuous paper 10 to the transport unit 2. The take-up roller 12 winds the continuous paper 10 in a roll shape. In the inkjet printing apparatus 1, the unwinding roller 11 and the take-up roller 12 transport the continuous paper 10 in a roll-to-roll system.

The transport unit 2 transports the continuous paper 10 supplied from the unwinding roller 11 to the take-up roller 12. The transport unit 2 has a drive roller 21, a nip roller 23, and a plurality of transport rollers 25. The drive roller 21 is connected to a motor and is caused to rotate actively by power from the motor. The nip roller 23 interposes the continuous paper 10 together with the drive roller 21. The nip roller 23 presses the drive roller 21 via the continuous paper 10, thereby generating grip force for the drive roller 21 to transport the continuous paper 10. The transport rollers 25 rotate passively. At least some of the transport rollers 25 may be configured to rotate actively.

The printing unit 3 includes four head units 35 and four ink suppliers 4. The four head units 35 have the same configuration, and the four ink suppliers 4 have the same configuration.

The four head units 35 are aligned at intervals from each other in a transport direction. Each of the four head units 35 ejects droplets of the ink from a nozzle 83 toward a surface of the continuous paper 10. The four head units 35 eject inks of respective colors differing from each other (cyan, magenta, yellow, and black, for example), thereby recording respective single-color images on the surface of the continuous paper 10. The four single-color images are superimposed on each other to form a multicolor image on an upper surface of the continuous paper 10.

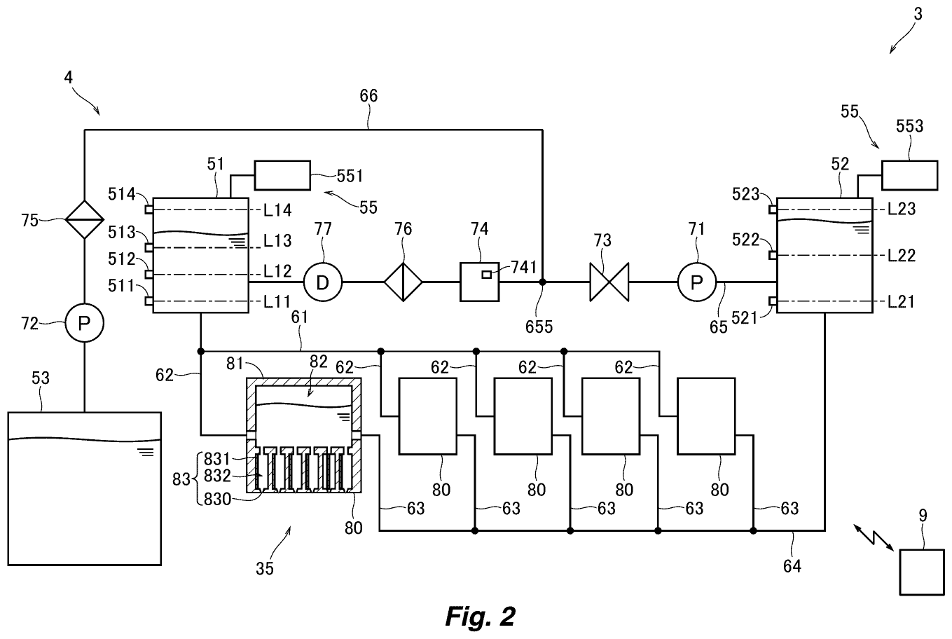

FIG. 2 is a view conceptually showing the configurations of one ink supplier 4 and one head unit 35. In the present embodiment, each head unit 35 has a plurality of ejection heads 80. In this example, each head unit 35 has five ejection heads 80. The ejection heads 80 have the same configuration. In FIG. 2, only one ejection head 80 is illustrated in detail and the other four ejection heads 80 are illustrated in a simplified manner. As shown in FIG. 2, the ejection head 80 has a casing 81, an inner tank 82 and a plurality of the nozzles 83.

The casing 81 forms an outer frame of the ejection head 80. The inner tank 82 is arranged inside the casing 81 and is available for storing the ink temporarily. The nozzles 83 are arranged at a lower part of the casing 81 and aligned at equal intervals from each other in the transport direction and a width direction of the continuous paper 10. Each of the nozzles 83 communicates with the inner tank 82. Each nozzle 83 includes a piezoelectric element 831, an ink chamber 832, and an ejection port 830. The piezoelectric element 831 is a pressure-generating element. The ink chamber 832 communicates with the inner tank 82.

The ink in the inner tank 82 flows down into the ink chamber 832. Then, the ink in the ink chamber 832 is pressurized by the piezoelectric element 831 to eject droplets of the ink from the ejection port 830. A system of ejecting the ink may be a so-called thermal system of using a heater as a pressure-generating element.

The ink supplier 4 is a device to circulate the ink by supplying the ink to the head unit 35 and recovering the ink not having been ejected from the head unit 35. The four ink suppliers 4 have the same configuration.

As shown in FIG. 2, the ink supplier 4 includes a supply tank 51, a recovery tank 52, a replenishment tank 53, a supply-side manifold 61, a plurality of (in the present embodiment, five) supply-side branch pipes 62, a plurality of (in the present embodiment, five) recovery-side branch pipes 63, a recovery-side manifold 64, a connection pipe 65, a replenishment pipe 66, a circulation pump 71, a replenishment pump 72, a backflow check on-off valve 73, a heater 74, a first filter 75, a second filter 76, and a degassing unit 77.

The supply tank 51 is a container for temporarily storing the ink to be supplied to the head unit 35. The supply tank 51 has an inner chamber. The inner chamber is available for temporarily storing the ink.

The supply tank 51 is mounted with four liquid level sensors 511, 512, 513, and 514. The liquid level sensors 511 to 514 are electrically connected to the controller 9. Each of the liquid level sensors 511 to 514 detects the height of the liquid level of the ink stored in the inner chamber of the supply tank 51, and outputs a signal to the controller 9. The liquid level sensor 511 determines whether the height of the liquid level is equal to or greater than a supply level L11. The liquid level sensor 512 determines whether the height of the liquid level is equal to or greater than a supply level L12. The liquid level sensor 513 determines whether the height of the liquid level is equal to or greater than a supply level L13. The liquid level sensor 514 determines whether the height of the liquid level is equal to or greater than a supply level L14. The supply level L12 is a level higher than the supply level L11. The supply level L13 is a level higher than the supply level L12. The supply level L14 is a level higher than the supply level L13. The height of the liquid level shows a remaining amount of the stored ink. As the height (level) of the liquid level increases, a remaining amount of the ink becomes larger. Each of the liquid level sensors 511 to 514 is an example of a “supply tank remaining amount detector” that detects a remaining amount of the ink in the supply tank 51 (hereinafter “supply tank remaining amount”). The liquid level sensors 511 to 514 are capacitive level sensors. However, the supply tank remaining amount detector may be a liquid level reflective level sensor, for example.

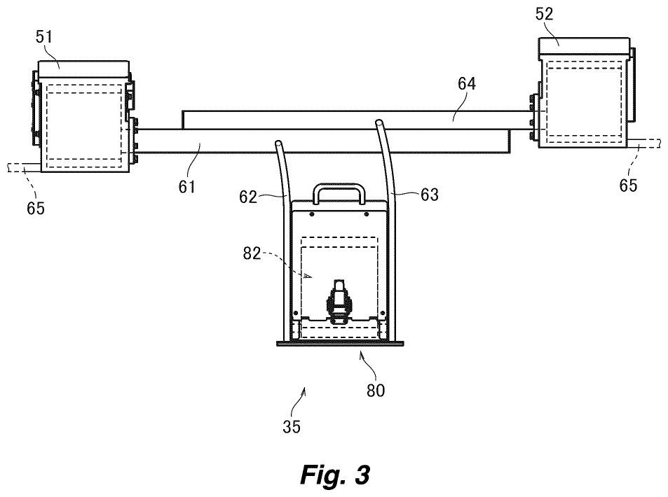

The supply-side manifold 61 and the five supply-side branch pipes 62 form connection between the supply tank 51 and the five ejection heads 80 belonging to one head unit 35. FIG. 3 is a perspective view showing a part of the head unit 35 and a part of the ink supplier 4. FIG. 3 shows only one of the five ejection heads 80 belonging to the head unit 35, only one of the five supply-side branch pipes 62 linked to the supply-side manifold 61, and only one of the five recovery-side branch pipes 63 linked to the recovery-side manifold 64.

As shown in FIGS. 2 and 3, an upstream end of the supply-side manifold 61 is communicably connected to the inner chamber of the supply tank 51. The five supply-side branch pipes 62 branch from the supply-side manifold 61. The supply-side manifold 61 is a pipe thicker than the supply-side branch pipe 62. An upstream end of each supply-side branch pipe 62 communicates with an inner passage of the supply-side manifold 61. A downstream end of each supply-side branch pipe 62 is communicably connected to the inner tank 82 of one ejection head 80. The supply-side manifold 61 or the supply-side branch pipe 62 may have an on-off valve, a filter or the like.

The five recovery-side branch pipes 63 and the recovery-side manifold 64 form connection between the five ejection heads 80 belonging to one head unit 35 and the recovery tank 52. As shown in FIGS. 2 and 3, the five recovery-side branch pipes 63 are thin pipes branching from the recovery-side manifold 64. An upstream end of each recovery-side branch pipe 63 is communicably connected to the inner tank 82 in one ejection head 80. A downstream end of each recovery-side branch pipe 63 is communicably connected to an inner passage of the recovery-side manifold 64. A downstream end of the recovery-side manifold 64 is communicably connected to an inner chamber of the recovery tank 52. The recovery-side manifold 64 is a pipe thicker than the recovery-side branch pipe 63. The recovery-side branch pipe 63 or the recovery-side manifold 64 may have an on-off valve, a filter or the like.

The recovery tank 52 temporarily stores the ink recovered from the head unit 35. The recovery tank 52 has the inner chamber for storing the ink.

The recovery tank 52 is mounted with three liquid level sensors 521, 522, and 523. The liquid level sensors 521 to 523 are electrically connected to the controller 9. Each of the liquid level sensors 521 to 523 detects the height of the liquid level of the ink stored in the inner chamber of the recovery tank 52. The liquid level sensor 521 determines whether the height of the liquid level is equal to or greater than a first level L21. The liquid level sensor 522 determines whether the height of the liquid level is equal to or greater than a recovery level L22. The liquid level sensor 523 determines whether the height of the liquid level is equal to or greater than a recovery level L23. The recovery level L22 is a level higher than the recovery level L21. The third recovery level L23 is a level higher than the second recovery level L22. Each of the liquid level sensors 521 to 523 is an example of a “recovery tank remaining amount detector” that detects a remaining amount of the ink in the recovery tank 52 (hereinafter called a “recovery tank remaining amount”). The liquid level sensors 521 to 523 are capacitive level sensors. However, the recovery tank remaining amount detector may be a liquid level reflective level sensor, for example.

As shown in FIG. 2, the ink supplier 4 includes a pressure difference generator 55. The pressure difference generator 55 is connected to the supply tank 51 and the recovery tank 52. The pressure difference generator 55 generates a pressure difference between the inner chamber of the supply tank 51 and the inner chamber of the recovery tank 52 by regulating a pressure (internal pressure) in the inner chamber of the supply tank 51 and a pressure (internal pressure) in the inner chamber of the recovery tank 52.

To be specific, the pressure difference generator 55 includes a pressurizer 551 and a decompressor 553. The pressurizer 551 and the decompressor 553 are controlled by the controller 9. The pressurizer 551 generates a positive pressure larger than atmospheric pressure as the internal pressure in the supply tank 51 by supplying gas to the inner chamber of the supply tank 51, for example. The decompressor 553 generates a negative pressure lower than atmospheric pressure as the internal pressure in the recovery tank 52 by suctioning gas from the inner chamber of the recovery tank 52, for example.

By the differential pressure generated by the pressure difference generator 55, the ink stored in the supply tank 51 is fed to the inner tank 82 of each ejection head 80 through the supply-side manifold 61 and each supply-side branch pipe 62. By the differential pressure generated by the pressure difference generator 55, the ink not having been ejected from each ejection head 80 is fed to the recovery tank 52 through each recovery-side branch pipe 63 and the recovery-side manifold 64.

The connection pipe 65 communicably connects the inner chamber of the supply tank 51 and the inner chamber of the recovery tank 52 to each other. As shown in FIG. 2, an upstream end of the connection pipe 65 is communicably connected to the inner chamber of the recovery tank 52. A downstream end of the connection pipe 65 is communicably connected to the inner chamber of the supply tank 51. The connection pipe 65 is mounted with the circulation pump 71, the backflow check on-off valve 73, the heater 74, the second filter 76, and the degassing unit 77. The replenishment pipe 66 is connected to a connection point 655 between the backflow check on-off valve 73 and the heater 74 in the connection pipe 65.

The circulation pump 71 makes a feeding motion of feeding the ink from the recovery tank 52 to the supply tank 51. The circulation pump 71 generates a flow of the ink from the recovery tank 52 toward the supply tank 51 in an inner passage of the connection pipe 65. Preferably, the circulation pump 71 is a diaphragm pump where a foreign matter such as dust is unlikely to occur during driving thereof. A flow rate at the circulation pump 71 is changed between magnitudes at a plurality of stages by a control signal output by the controller 9. A flow rate at the circulation pump 71 is changed at least between three stages including zero (second circulation flow rate), a basic circulation flow rate higher than zero, and a high circulation flow rate (first circulation flow rate) higher than the basic circulation flow rate.

The backflow check on-off valve 73 is located downstream from the circulation pump 71 and upstream from the connection point 655 in the connection pipe 65. Closing the backflow check on-off valve 73 cuts the connection pipe 65. Specifically, while the backflow check on-off valve 73 is closed, backflow of the ink from the connection point 655 toward the circulation pump 71 is prevented. Opening the backflow check on-off valve 73 forms communication through the connection pipe 65.

The heater 74 heats the ink passing through the connection pipe 65. The heater 74 is located between the connection point 655 and the supply tank 51 in the connection pipe 65. The heater 74 includes a temperature sensor 741. The temperature sensor 741 measures the temperature of the ink flowing into the heater 74. The temperature sensor 741 may measure the temperature of the ink having passed through the heater 74. The heater 74 is electrically connected to the controller 9. The heater 74 outputs data indicating the temperature measured by the temperature sensor 741 to the controller 9. The controller 9 controls the heater 74 on the basis of the temperature measured by the temperature sensor 741.

The second filter 76 is located between the connection point 655 and the supply tank 51 in the connection pipe 65. The second filter 76 filters the ink flowing in the connection pipe 65 to remove a foreign matter from the ink. A pore diameter of the second filter 76 (the size of openings of the second filter 76) is from 4 to 6 μm, for example.

The degassing unit 77 is located between the connection point 655 and the supply tank 51 in the connection pipe 65. The degassing unit 77 of the present embodiment is a hollow fiber membrane degassing module, for example. The degassing unit 77 removes air bubbles from the ink flowing in the connection pipe 65.

The replenishment tank 53 stores the ink to be replenished into the supply tank 51. The replenishment tank 53 has an inner chamber available for storing the ink. The replenishment tank 53 is located outside a circulation flow path for the ink to circulate between the above-described supply tank 51 and recovery tank 52.

The replenishment pipe 66 communicably connects the inner chamber of the replenishment tank 53 and the connection pipe 65 to each other. As shown in FIG. 2, the replenishment pipe 66 is connected at an upstream end thereof to the inner chamber of the replenishment tank 53. The replenishment pipe 66 is connected at the connection point 655 as a downstream end thereof to the connection pipe 65. The connection point 655 is located between the circulation pump 71 and the supply tank 51 in the connection pipe 65. The connection point 655 is located between the backflow check on-off valve 73 and the supply tank 51 in the connection pipe 65. The replenishment pipe 66 is mounted with the replenishment pump 72 and the first filter 75.

The replenishment pump 72 makes a feeding motion of feeding the ink from the replenishment tank 53 to the connection pipe 65. The replenishment pump 72 is a diaphragm pump, for example. A flow rate at the replenishment pump 72 is changed between magnitudes at a plurality of stages by a control signal output by the controller 9. A flow rate at the replenishment pump 72 will hereinafter be called a “replenishment flow rate.” The replenishment flow rate is changed at least between three stages including a basic replenishment flow rate that is zero, a high replenishment flow rate (first replenishment flow rate) higher than the basic replenishment flow rate, and a low replenishment flow rate (second replenishment flow rate) higher than the basic replenishment flow rate and lower than the high replenishment flow rate.

The first filter 75 is located between the replenishment pump 72 and the connection point 655 in the replenishment pipe 66. The first filter 75 filters the ink flowing in the replenishment pipe 66 to remove a foreign matter from the ink. A pore diameter of the first filter 75 (the size of openings of the first filter 75) is from about 10 to 30 μm, for example. Namely, the pore diameter of the first filter 75 is equal to or greater than the pore diameter of the second filter 76. However, the pore diameter of the first filter 75 may be less than the pore diameter of the second filter 76.

The controller 9 is an information processor for controlling each unit of the inkjet printing apparatus 1. As shown in FIG. 1, the controller 9 includes a processor 91 such as a CPU, a memory 92 such as a RAM, and a storage 93 such as a hard disk drive. The storage 93 stores a program 931 for implementation of a process of performing a printing process while transporting the continuous paper 10, and a process of supplying the ink to the head unit 35. The storage 93 stores print data 933 indicating an image to be printed on the continuous paper 10.

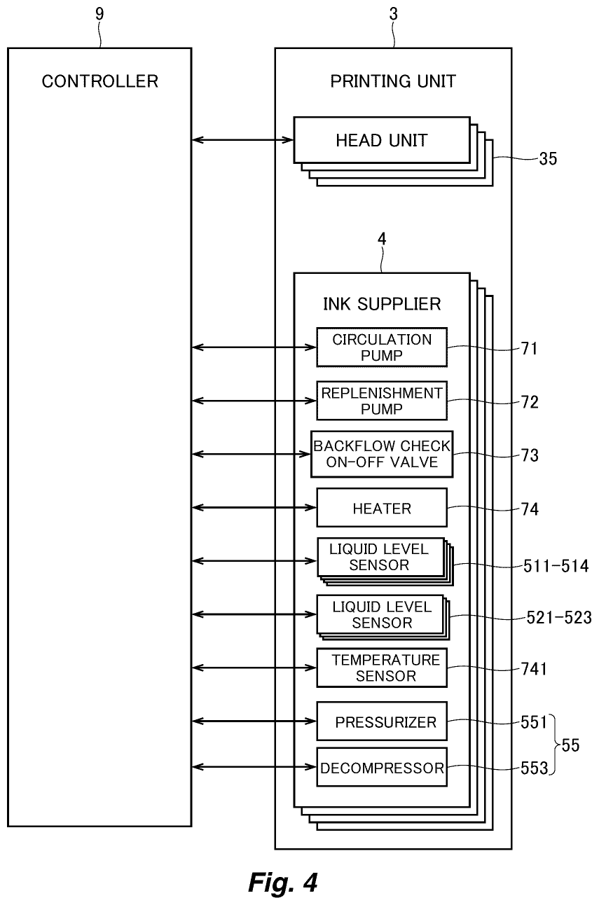

FIG. 4 is a block diagram showing connection between the controller 9 and each unit of the inkjet printing apparatus 1. As shown in FIG. 4, the controller 9 is communicably connected to the transport unit 2, each head unit 35, and the circulation pump 71, the replenishment pump 72, the backflow check on-off valve 73, the heater 74, the liquid level sensors 511 to 514, the liquid level sensors 521 to 523, the temperature sensor 741, the pressurizer 551, and the decompressor 553 of each ink supplier 4. The controller 9 controls the motion of each of these units according to the program 931. By doing so, transport of the continuous paper 10 and the printing process proceed, and the ink is supplied to the inner tank 82 of each ejection head 80.

### Circulation Process

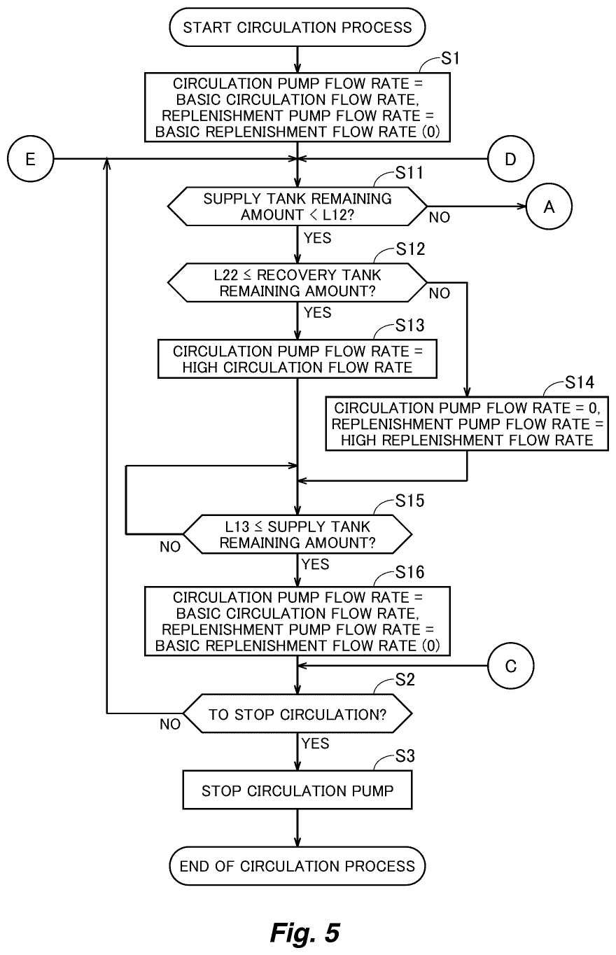

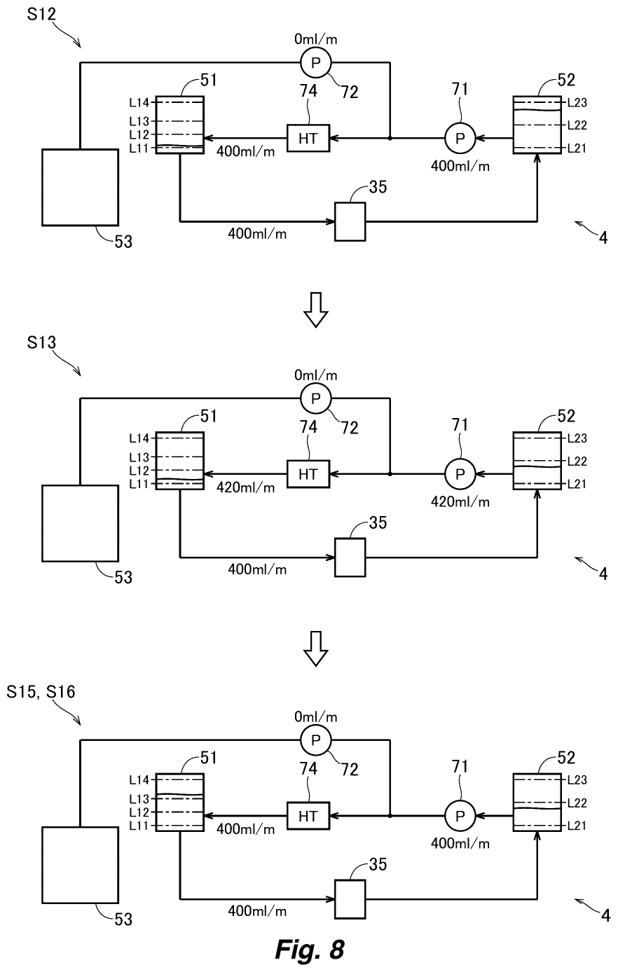

FIGS. 5 to 7 are views showing a flow of a circulation process performed by the controller 9. The circulation process is a process for circulating the ink at the ink supplier 4. FIGS. 8 to 13 are views showing corresponding states of the ink supplier 4 in the circulation process.

During the circulation process, the pressure difference generator 55 feeds the ink of a constant amount from the supply tank 51 to the head unit 35. In the following explanation, the flow rate of the ink to be fed from the supply tank 51 to the head unit 35 by the pressure difference generator 55 (the flow rate of the ink to pass through the supply-side manifold 61) will be called a “feeding flow rate.” The feeding flow rate is 400 ml/min, for example.

During the circulation process, the controller 9 causes the heater 74 to work, thereby heating the ink passing through the heater 74. If the flow of the ink at the heater 74 is stopped or decelerated while the heater 74 is at a high temperature, the ink is brought to a high temperature with the heat of the heater 74, resulting in a risk of developing degradation of the ink. To avoid such overheating of the ink, the controller 9 controls the circulation pump 71 and the replenishment pump 72 in such a manner that the flow rate of the ink at the heater 74 becomes equal to or greater than a limit flow rate. Specifically, the limit flow rate means the flow rate of the ink of such an extent as to allow reduction of degradation of the ink due to overheating at the heater 74. The limit flow rate is 50 ml/min, for example. However, the limit flow rate may be a value equal to or greater than 50 ml/min. The limit flow rate may change in response to the type of the heater 74 and the type of the ink.

When the circulation process is started, the controller 9 first sets a flow rate at the circulation pump 71 to the basic circulation flow rate and sets a flow rate at the replenishment pump 72 to the basic replenishment flow rate (zero) (FIG. 5: step S1). The basic circulation flow rate is 400 ml/min, for example. The basic circulation flow rate at the circulation pump 71 and the basic replenishment flow rate (zero) at the replenishment pump 72 conform to a feeding flow rate determined by the pressure difference generator 55. By setting a flow rate at the circulation pump 71 to the basic circulation flow rate and setting a flow rate at the replenishment pump 72 to the basic replenishment flow rate while the ink is not ejected from the ejection head 80, a supply tank remaining amount and a recovery tank remaining amount are kept substantially constantly. A sum of the basic circulation flow rate and the basic replenishment flow rate is not essentially required to conform to the feeding flow rate but the sum and the feeding flow rate may differ from each other.

After step S1, the controller 9 judges whether the supply tank remaining amount is less than the supply level L12 (FIG. 5: step S11). If the supply tank remaining amount is judged to be less than the supply level L12 by step S11 (if YES in step S11), the controller 9 judges whether the recovery tank remaining amount is equal to or greater than the recovery level L22 (FIG. 5: step S12).

If the recovery tank remaining amount is judged to be equal to or greater than the recovery level L22 by step S12 (if YES in step S12), the controller 9 sets a flow rate at the circulation pump 71 to the high circulation flow rate higher than the basic circulation flow rate (FIG. 5: step S13). The high circulation flow rate is 420 ml/min, for example (see FIG. 8).

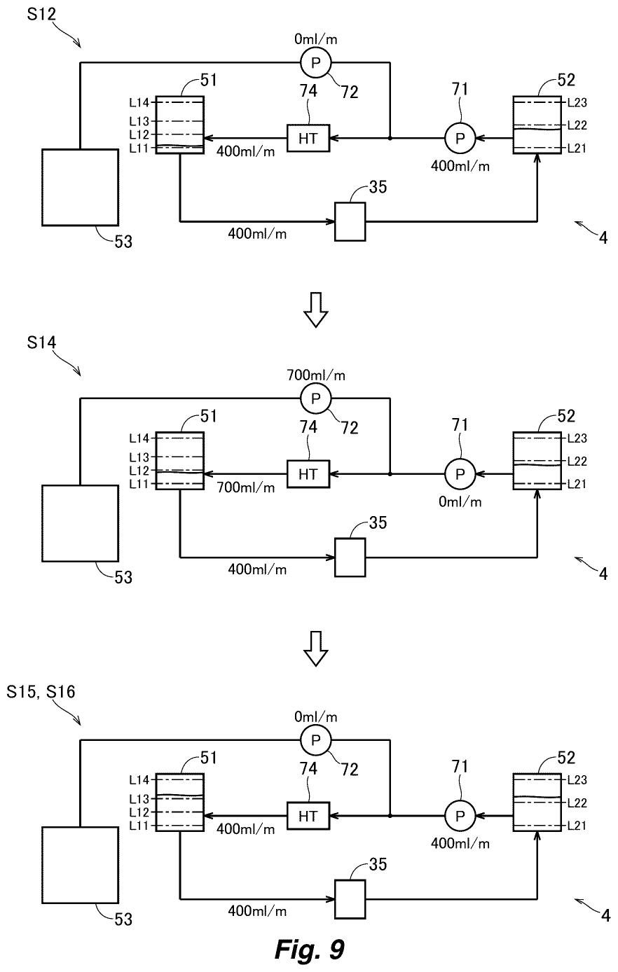

If the recovery tank remaining amount is judged not to be equal to or greater than the recovery level L22 by step S12 (if NO in step S12), the controller 9 sets a flow rate at the circulation pump 71 to zero and sets a flow rate at the replenishment pump 72 to the high replenishment flow rate (FIG. 5: step S14). The high replenishment flow rate at the replenishment pump 72 is 700 ml/min, for example (see FIG. 9). In step S14, the controller 9 closes the backflow check on-off valve 73 before driving the replenishment pump 72. By doing so, the ink replenished from the replenishment tank 53 is fed to the heater 74, eventually, to the supply tank 51 instead of being fed to the recovery tank 52.

After step S13 or step S14, the controller 9 judges whether the supply tank remaining amount is equal to or greater than the supply level L13 (FIG. 5: step S15). If the supply tank remaining amount is judged to be equal to or greater than the supply level L13 by step S15 (if YES in step S15), the controller 9 sets a flow rate at the circulation pump 71 to the basic circulation flow rate and sets a flow rate at the replenishment pump 72 to the basic replenishment flow rate (zero) (FIG. 5: step S16). If the backflow check on-off valve 73 is closed, the controller 9 opens the backflow check on-off valve 73 and then drives the circulation pump 71 in step S16. If the supply tank remaining amount is judged not to be equal to or greater than the supply level L13 by step S15 (if NO in step S15), the controller 9 performs step S15 repeatedly.

If the supply tank remaining amount is equal to or greater than the supply level L13, the supply tank remaining amount is sufficiently large. Thus, as shown in FIG. 8, replenishment of the ink from the recovery tank 52 or from the replenishment tank 53 into the supply tank 51 is stopped as a result of implementation of step S16.

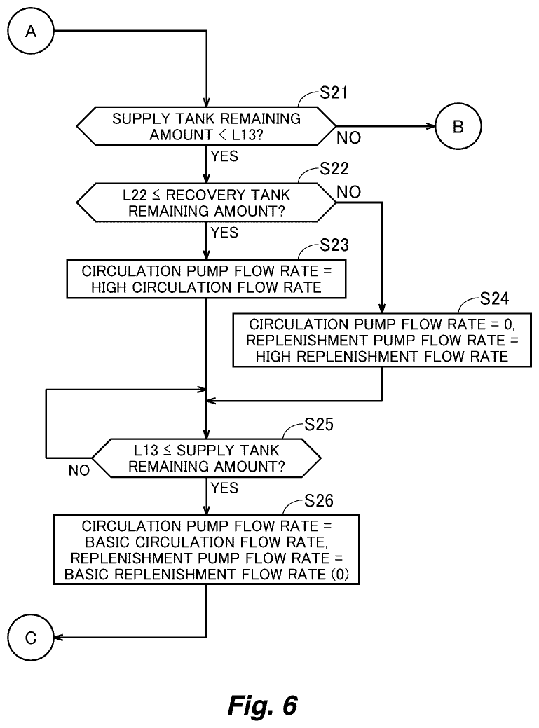

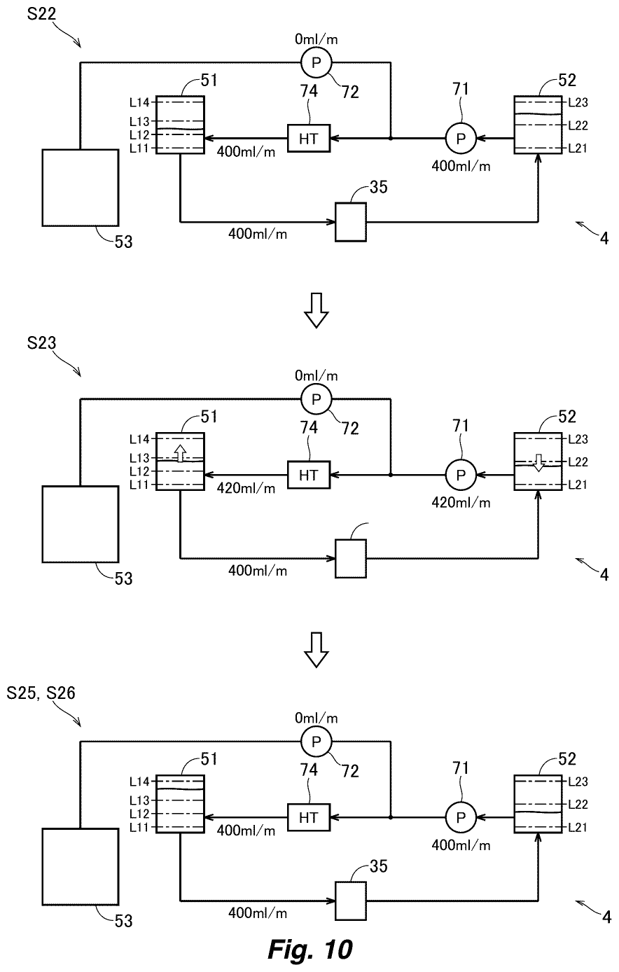

If the supply tank remaining amount is judged not to be less than the supply level L12 by step S11 (if NO in step S11), the controller 9 judges whether the supply tank remaining amount is less than the supply level L13 (FIG. 6: step S21). If the supply tank remaining amount is judged to be less than the supply level L13 by step S21 (if YES in step S21), the controller 9 judges whether the recovery tank remaining amount is equal to or greater than the recovery level L22 (FIG. 6: step S22). If the recovery tank remaining amount is judged to be equal to or greater than the recovery level L22 by step S22 (if YES in step S22), the controller 9 sets a flow rate at the circulation pump 71 to the high circulation flow rate higher than the basic circulation flow rate (FIG. 6: step S23). The high circulation flow rate is 420 ml/min, for example (see FIG. 10).

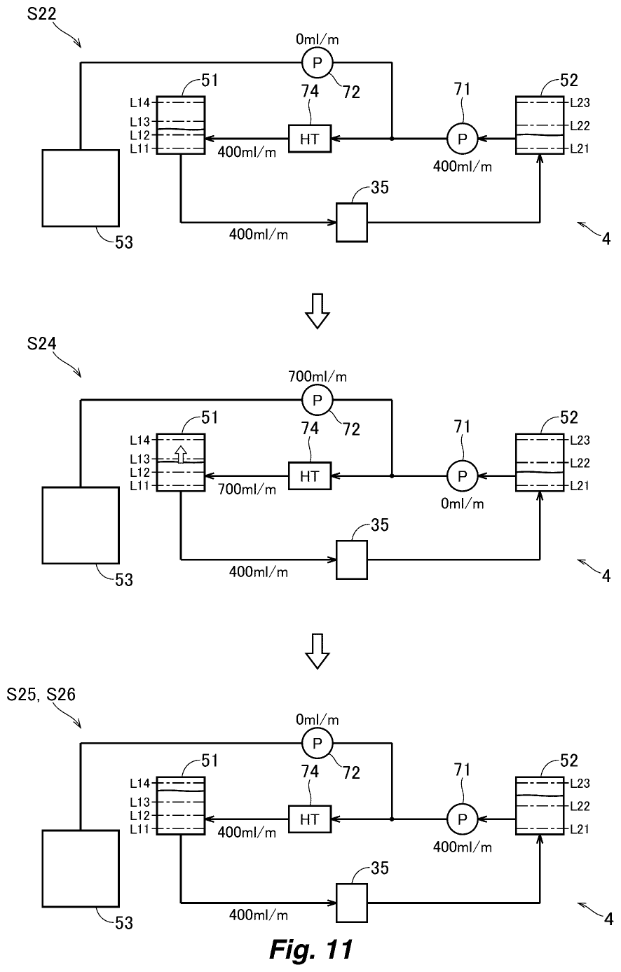

If the recovery tank remaining amount is judged not to be equal to or greater than the recovery level L22 by step S22 (if NO in step S22), the controller 9 sets a flow rate at the circulation pump 71 to zero and sets a flow rate at the replenishment pump 72 to the high replenishment flow rate (FIG. 6: step S24). The high replenishment flow rate is 700 ml/min, for example (see FIG. 11). In step S24, the controller 9 closes the backflow check on-off valve 73 before driving the replenishment pump 72. By doing so, the ink replenished from the replenishment tank 53 is fed to the heater 74, eventually, to the supply tank 51 instead of being fed to the recovery tank 52.

After step S23 or step S24, the controller 9 judges whether the supply tank remaining amount is equal to or greater than the supply level L13 (FIG. 6: step S25). If the supply tank remaining amount is judged to be equal to or greater than the supply level L13 by step S25 (if YES in step S25), the controller 9 sets a flow rate at the circulation pump 71 to the basic circulation flow rate and sets a flow rate at the replenishment pump 72 to the basic replenishment flow rate (zero) (FIG. 6: step S26). If the backflow check on-off valve 73 is closed, the controller 9 opens the backflow check on-off valve 73 and then drives the circulation pump 71 in step S26. If the supply tank remaining amount is judged not to be equal to or greater than the supply level L13 by step S25 (if NO in step S25), the controller 9 performs step S25 repeatedly.

In step S25, if the supply tank remaining amount is equal to or greater than the supply level L13, the supply tank remaining amount is sufficiently large. Thus, as a result of implementation of step S26, the controller 9 stops replenishment of the ink from the recovery tank 52 or from the replenishment tank 53 into the supply tank 51 (see FIG. 11).

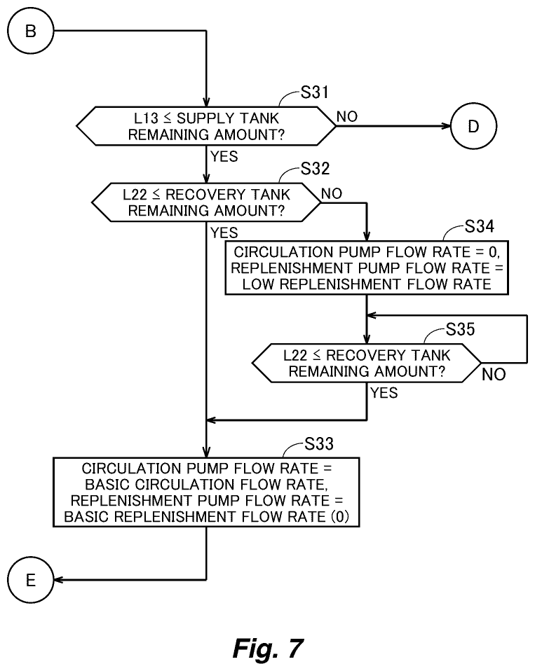

If the supply tank remaining amount is judged not to be less than the supply level L13 by step S21 (if NO in step S21), the controller 9 judges whether the supply tank remaining amount is equal to or greater than L13 (FIG. 7: step S31). If the supply tank remaining amount is judged to be equal to or greater than L13 by step S31 (if YES in step S31), the controller 9 judges whether the recovery tank remaining amount is equal to or greater than the recovery level L22 (FIG. 7: step S32).

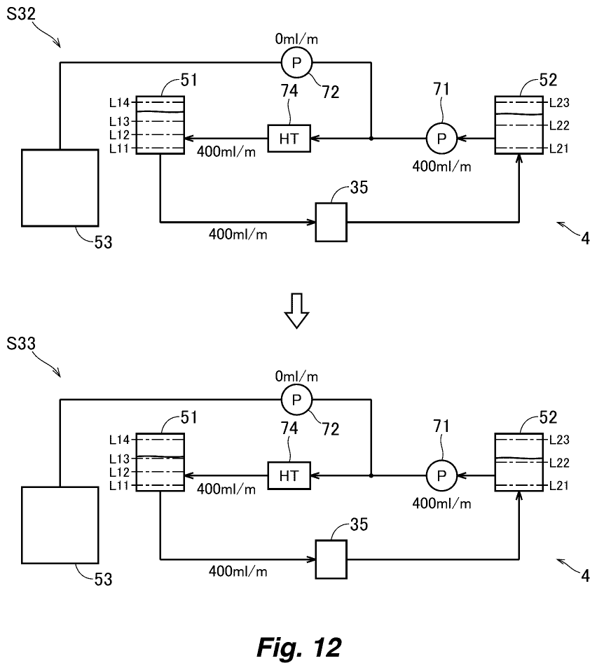

If the recovery tank remaining amount is judged to be equal to or greater than the recovery level L22 by step S32 (if YES in step S32), the controller 9 sets a flow rate at the circulation pump 71 to the basic circulation flow rate and sets a flow rate at the replenishment pump 72 to the basic replenishment flow rate (zero) ((FIG. 7: step S33) As shown in FIG. 12, if the supply tank remaining amount is equal to or greater than the supply level L13 and if the recovery tank remaining amount is equal to or greater than the recovery level L22, the supply tank remaining amount and the recovery tank remaining amount are sufficiently large. Thus, it is not required to replenish the ink into the supply tank 51 and the recovery tank 52. For this reason, the controller 9 sets a flow rate at the circulation pump 71 to the basic circulation flow rate (400 ml/min) and sets a flow rate at the replenishment pump 72 to the basic replenishment flow rate (zero). In this case, the flow rate of the ink at the heater 74 is the same as the basic circulation flow rate.

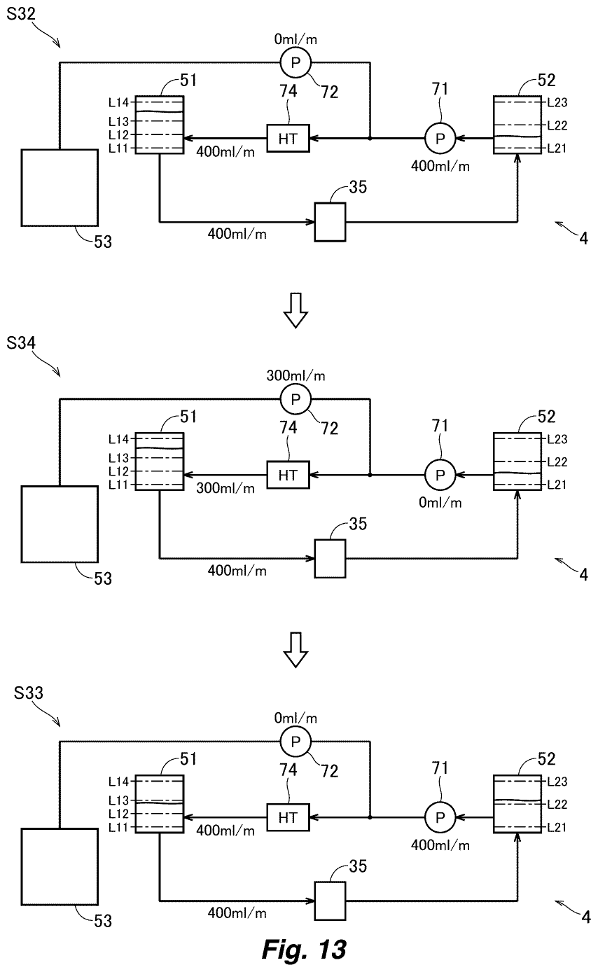

If the recovery tank remaining amount is judged not to be equal to or greater than the recovery level L22 by step S32 (if NO in step S32), the controller 9 sets a circulation flow rate at the circulation pump 71 to zero and sets a flow rate at the replenishment pump 72 to the low replenishment flow rate (FIG. 7: step S34). The low replenishment flow rate is 300 ml/min, for example (see FIG. 13). As a result of implementation of step S34, the flow rate of the ink to pass through the heater 74 becomes a value equal to the low replenishment flow rate.

After step S34, the controller 9 judges whether the recovery tank remaining amount is equal to or greater than the recovery level L22 (FIG. 7: step S35). If the recovery tank remaining amount is judged to be equal to or greater than the recovery level L22 (if YES in step S35), step S33 described above is performed. Meanwhile, if the recovery tank remaining amount is judged not to be equal to or greater than the recovery level L22 (if NO in step S35), the controller 9 performs step S35 repeatedly.

After step S33, the controller 9 performs step S11 again.

After step S16 or step S26, the controller 9 judges whether to stop the circulation (FIG. 5: step S2). If the circulation is judged to be stopped by step S2 (if YES in step S2), the controller 9 stops driving of the circulation pump 71 (step S3). If the circulation is judged to be stopped by step S2, the controller 9 performs step S11 again. The explanation of the circulation process ends here.

### Effects

In the inkjet printing apparatus 1, while the heater 74 is working, the controller 9 controls the circulation pump 71 and the replenishment pump 72 in such a manner that the flow rate of the ink to pass through the heater 74 becomes equal to or greater than the limit flow rate. This makes it possible to reduce degradation of the ink due to overheating.

In the inkjet printing apparatus 1, the controller 9 controls the circulation pump 71 and the replenishment pump 72 on the basis of the supply tank remaining amount detected by the liquid level sensors 511 to 514 and the recovery tank remaining amount detected by the liquid level sensors 521 to 523. This allows the circulation pump and the replenishment pump to be controlled in such a manner that the ink remaining amount in the supply tank 51 and the ink remaining amount in the recovery tank 52 become proper amounts.

As shown in FIG. 12, if the supply tank remaining amount is equal to or greater than a first supply remaining amount (supply level L12) and if the recovery tank remaining amount is equal to or greater than a first recovery remaining amount (recovery level L22), the controller 9 sets a flow rate at the circulation pump 71 to the basic circulation flow rate (400 ml/min) and sets a flow rate at the replenishment pump 72 to the basic replenishment flow rate (zero) (step S35). A sum of the basic circulation flow rate and the basic replenishment flow rate is equal to or greater than the limit flow rate. This makes it possible to reduce degradation of the ink due to overheating.

As shown in FIG. 8, if the supply tank remaining amount is less than the first supply remaining amount (supply level L12), the controller 9 sets a flow rate at the circulation pump 71 to the first circulation flow rate (420 ml/min) higher than the basic circulation flow rate (400 ml/min). This allows the ink to be replenished from the recovery tank into the supply tank.

As shown in FIG. 8, if the supply tank remaining amount is less than the first supply remaining amount (supply level L12), the controller 9 sets a flow rate at the replenishment pump 72 to the basic replenishment flow rate (zero). A sum of the first circulation flow rate and the basic replenishment flow rate is equal to or greater than the limit flow rate. This makes it possible to reduce degradation of the ink due to overheating.

As shown in FIG. 9 or 11, if the recovery tank remaining amount is less than the first recovery remaining amount (supply level L12), the controller 9 sets a flow rate at the circulation pump 71 to the second circulation flow rate (zero) lower than the basic circulation flow rate (400 ml/min) and sets a flow rate at the replenishment pump 72 to the first replenishment flow rate (700 ml/min) higher than the basic replenishment flow rate (zero). A sum of the second circulation flow rate and the first replenishment flow rate is equal to or greater than the limit flow rate. Even if a flow rate at the circulation pump 71 is reduced for avoiding reduction in the recovery tank remaining amount, it is still possible to make a flow rate at the heater higher than the limit flow rate by increasing a flow rate at the replenishment pump 72.

As shown in FIG. 13, if the recovery tank remaining amount is less than the first recovery remaining amount (supply level L12) and if the supply tank remaining amount is equal to or greater than a second supply remaining amount (supply level L13) larger than the first supply remaining amount (supply level L12), the controller 9 sets a flow rate at the circulation pump 71 to a third circulation flow rate (zero) lower than the basic circulation flow rate (400 ml/min) and sets a flow rate at the replenishment pump 72 to the second replenishment flow rate (300 ml/min) lower than the first replenishment flow rate (700 ml/min). A sum of the third circulation flow rate and the second replenishment flow rate is equal to or greater than the limit flow rate. This makes it possible to reduce degradation of the ink due to overheating while avoiding overflow of the supply tank.

In the explanation given above, the controller 9 sets a flow rate at the circulation pump 71 to zero in step S14, S24, or S34. However, the controller 9 may set a flow rate at the circulation pump 71 to a low circulation flow rate higher than zero and lower than the basic circulation flow rate. During implementation of the printing process of ejecting the ink from the ejection head 35 to the continuous paper 10, the controller 9 may set a flow rate at the circulation pump 71 to a flow rate higher than zero in step S14. In this case, as a larger amount of the ink is replenished into the supply tank 51 than in a case of setting a flow rate at the circulation pump 71 to zero, it is possible to avoid shortage of the ink in the supply tank 51. This allows the printing process to be performed properly.

The limit flow rate (lower limit flow rate) may be invariant or changeable. The limit flow rate may be changed stepwise in response to the temperature of the ink entering the heater 74.

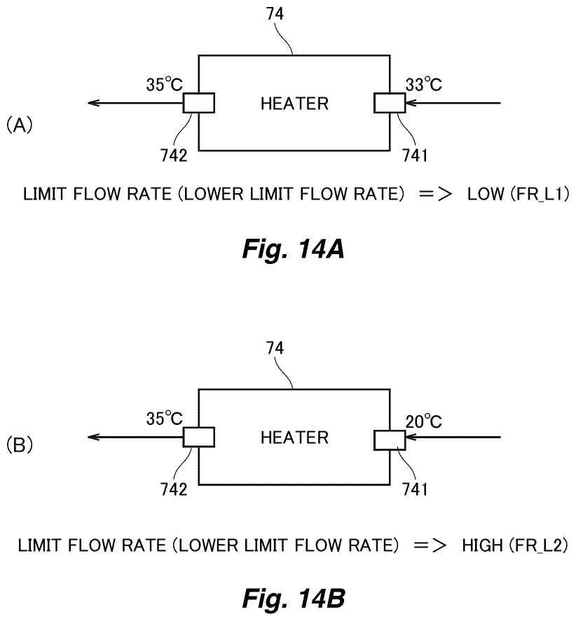

FIG. 14 is a view for explaining a relationship between the temperature of the ink entering the heater 74 and the limit flow rate. FIG. 14(A) shows a case where the temperature of the ink flowing into the heater 74 is 33° C. FIG. 14(B) shows a case where the temperature of the ink flowing into the heater 74 is 20° C. The temperature of the ink flowing into the heater is measured by the temperature sensor 741.

As shown in FIG. 14(A), if a temperature measured by the temperature sensor 741 (measured temperature that is 33° C. in this case) exceeds a predetermined threshold temperature, for example, the controller 9 sets the limit flow rate to FR_L1 that is comparatively low. On the other hand, if a temperature measured by the temperature sensor 741 (20° C. in this case) is lower than the predetermined threshold temperature as shown in FIG. 14(B), the controller 9 may set the limit flow rate to FR_L2 higher than FR_L1.

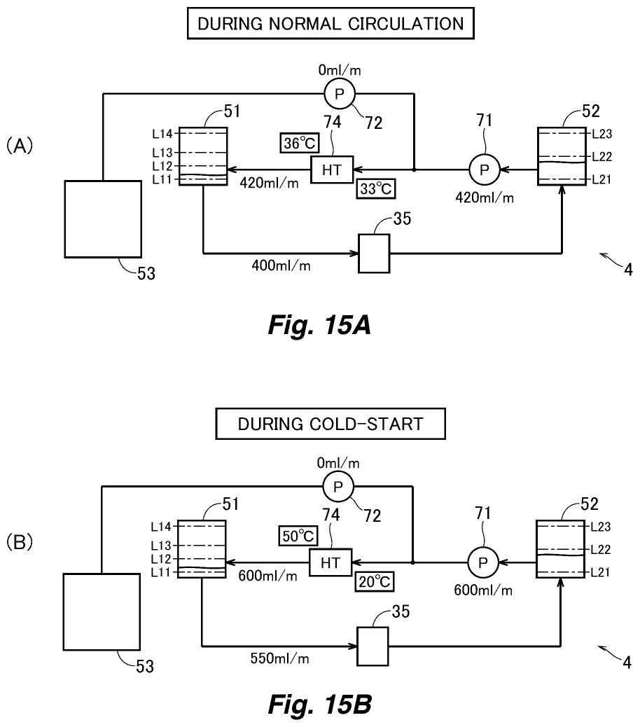

FIG. 15 is a view showing the state of the ink supplier 4. FIG. 15(A) shows the state of the ink supplier 4 during normal circulation. FIG. 15(B) shows the state of the ink supplier 4 during cold-start.

The state in FIG. 15(A) is the same as the state in step S13 shown in FIG. 8, and corresponds to a state during printing, for example. In this state, the temperature of the ink flowing into the heater 74 is 33° C. and a temperature set at the heater 74 is 36° C. In this state, the limit flow rate is set to FR_L1 that is comparatively low as described by referring to FIG. 14(A).

On the other hand, as shown in FIG. 15(B), the temperature of the ink flowing into the heater 74 is a temperature approximately equal to a room temperature (20° C., for example) during the cold-start of the inkjet printing apparatus 1. In this case, as described by referring to FIG. 14(B), the limit flow rate is set to FR_L2 higher than that during the normal circulation.

In the case of such cold-start, the controller 9 sets a temperature at the heater 74 to a comparatively high temperature (50° C., for example) in order to increase the temperature of the ink rapidly. Furthermore, the controller 9 sets a flow rate at the circulation pump 71 to a value (600 ml, for example) larger than a value (420 ml, for example) in the case of the normal circulation. Even in such a case where a temperature at the heater 74 is set to a high temperature in response to the temperature of the ink flowing into the heater 74, it is still possible to avoid overheating of the ink effectively by increasing a flow rate set at the circulation pump 71 in response to increase in the limit flow rate.

As shown in FIG. 14, the heater 74 may further include a temperature sensor 742 for measuring the temperature of the ink flowing out of the heater 74 in addition to the temperature sensor 741 for measuring the temperature of the ink flowing into the heater 74. In this case, the heater 74 transmits data to the controller 9, as appropriate, indicating temperatures measured by the temperature sensors 741 and 742. Then, the controller 9 may control the heater 74 using the temperatures measured by the temperature sensors 741 and 742.

In order for the controller 9 to control the heater 74, a target temperature may be set in advance for each of the temperature sensors 741 and 742, for example. Then, the controller 9 may control the heater 74 in such a manner that temperatures detected by the temperature sensors 741 and 742 become equal to the respective target temperatures. One target temperature may be set in advance for the temperature sensors 741 and 742. Then, the controller 9 may control the heater 74 in such a manner that an average of temperatures detected by the temperature sensors 741 and 742 becomes equal to the target temperature.

While the invention has been described in detail, the above description is in all aspects illustrative and the invention is not limited thereto. It is therefore understood that numerous modifications not shown can be devised without departing from the scope of the invention. The structures appearing in each of the above embodiments and each of the above modifications may be combined together or omitted, as appropriate, without inconsistencies.

### REFERENCE SIGNS LIST

1 Inkjet printing apparatus
10 Continuous paper
35 Head unit
51 Supply tank
511 to 514 Liquid level sensor (supply tank remaining amount detector)
52 Recovery tank
521 to 523 Liquid level sensor (recovery tank remaining amount detector)
53 Replenishment tank
55 Pressure difference generator (liquid feeder)
65 Connection pipe
66 Replenishment pipe
71 Circulation pump
72 Replenishment pump
74 Heater
9 Controller

1. An inkjet printing apparatus comprising:
an ejection head having a nozzle from which ink is ejected;
a supply tank storing the ink to be supplied to said ejection head;
a recovery tank storing the ink recovered from said ejection head;
a connection pipe forming connection between said supply tank and said recovery tank;
a heater located in said connection pipe and heating the ink in said connection pipe;
a circulation pump located between said heater and said recovery tank in said connection pipe and feeding the ink in said recovery tank to said supply tank;
a replenishment tank storing the ink to be replenished into said supply tank;
a replenishment pipe forming connection between said replenishment tank and said connection pipe;
a replenishment pump located in said replenishment pipe and feeding the ink in said replenishment tank to said connection pipe; and
a controller including a processor and a memory, the controller controlling said circulation pump and said replenishment pump by causing said processor to execute a program stored in said memory, wherein
said replenishment pipe is connected to a position between said heater and said recovery tank in said connection pipe, and
while said heater is working, said controller controls said circulation pump and said replenishment pump in such a manner that the flow rate of the ink to pass through said heater becomes equal to or greater than a limit flow rate.

2. The inkjet printing apparatus according to claim 1, comprising:
a supply tank remaining amount detector that detects a supply tank remaining amount showing the amount of the ink stored in said supply tank; and
a recovery tank remaining amount detector that detects a recovery tank remaining amount showing the amount of the ink stored in said recovery tank, wherein
said controller controls said circulation pump and said replenishment pump on the basis of said supply tank remaining amount detected by said supply tank remaining amount detector and said recovery tank remaining amount detected by said recovery tank remaining amount detector.

3. The inkjet printing apparatus according to claim 2, wherein
if said supply tank remaining amount detected by said supply tank remaining amount detector is equal to or greater than a first supply remaining amount and if said recovery tank remaining amount detected by said recovery tank remaining amount detector is equal to or greater than a first recovery remaining amount, said controller sets a flow rate at said circulation pump to a basic circulation flow rate and sets a flow rate at said replenishment pump to a basic replenishment flow rate, and
a sum of said basic circulation flow rate and said basic replenishment flow rate is equal to or greater than said limit flow rate.

4. The inkjet printing apparatus according to claim 3, wherein
if said supply tank remaining amount detected by said supply tank remaining amount detector is less than the first supply remaining amount, said controller sets a flow rate at said circulation pump to a first circulation flow rate higher than the basic circulation flow rate.

5. The inkjet printing apparatus according to claim 4, wherein
if said supply tank remaining amount detected by said supply tank remaining amount detector is less than the first supply remaining amount, said controller sets a flow rate at said replenishment pump to said basic replenishment flow rate, and
a sum of said first circulation flow rate and said basic replenishment flow rate is equal to or greater than said limit flow rate.

6. The inkjet printing apparatus according to claim 3, wherein
if said recovery tank remaining amount detected by said recovery tank remaining amount detector is less than the first recovery remaining amount, said controller sets a flow rate at said circulation pump to a second circulation flow rate lower than said basic circulation flow rate and sets a flow rate at said replenishment pump to a first replenishment flow rate higher than said basic replenishment flow rate, and
a sum of said second circulation flow rate and said first replenishment flow rate is equal to or greater than said limit flow rate.

7. The inkjet printing apparatus according to claim 6, wherein
if said recovery tank remaining amount detected by said recovery tank remaining amount detector is less than the first recovery remaining amount and if said supply tank remaining amount detected by said supply tank remaining amount detector is equal to or greater than a second supply remaining amount larger than the first supply remaining amount, said controller sets a flow rate at said circulation pump to a third circulation flow rate lower than said basic circulation flow rate and sets a flow rate at said replenishment pump to a second replenishment flow rate lower than said first replenishment flow rate, and
a sum of said third circulation flow rate and said second replenishment flow rate is equal to or greater than said limit flow rate.

8. The inkjet printing apparatus according to claim 3, further comprising:
a liquid feeder that feeds the ink from said supply tank toward said ejection head.

9. The inkjet printing apparatus according to claim 8, wherein
said controller controls said circulation pump and said replenishment pump in such a manner that a sum of said basic circulation flow rate and said basic replenishment flow rate becomes equal to the flow rate of the ink to be fed from said supply tank to said ejection head by said liquid feeder.

10. The inkjet printing apparatus according to claim 8, wherein
said liquid feeder makes an internal pressure in said supply tank higher than an internal pressure in said recovery tank.

11. The inkjet printing apparatus according to claim 1, wherein
said limit flow rate is equal to or greater than 50 ml/min.

12. The inkjet printing apparatus according to claim 1, further comprising:
a temperature sensor that measures the temperature of said ink flowing into said heater, wherein
said limit flow rate is changed in response to a temperature measured by said temperature sensor.

13. The inkjet printing apparatus according to claim 12, wherein
the limit flow rate determined if a measured temperature measured by said temperature sensor is lower than a predetermined threshold temperature is higher than the limit flow rate determined if said measured temperature exceeds said threshold temperature.
